(19) United States
(12) Patent Application Publication
(10) Pub. No.: US 2018/0373293 A1
(43) Pub. Date: Dec. 27, 2018

(54) TEXTILE DISPLAY SYSTEM AND METHOD

(71) Applicant: NEWTONOID TECHNOLOGIES, L.L.C., Liberty, MO (US)

(72) Inventors: FIELDING B. STATON, LIBERTY, MO (US); DAVID STRUMPF, COLUMBIA, MO (US)

(21) Appl. No.: 15/629,513

(22) Filed: Jun. 21, 2017

(51) Int. Cl. G06F 1/16; G09F 9/30

(52) U.S. Cl. CPC G06F 1/1652; G06F 1/163; G09F 21/02; G09F 9/301; G06F 1/1605

(57) ABSTRACT

The present disclosure includes wearable light emitting device display systems and methods. The wearable light emitting device includes: memory or a database that stores image and moving image files, a fabric with a multitude of light emitting devices defining a display, and a controller. The system can operate under several display modes: a static module displays at least one static image; a dynamic module displays at least a moving image or a moving pattern; a situational module displays a situational image or pattern upon occurrence of a predetermined event; a geographical module displays a geographic specific image or pattern; a motion module displays a motion specific image or pattern that displays only when the display is in motion. The system may further include a camera and a real time module that displays real time images captured from the camera.

### FIELD OF DISCLOSURE

Embodiments of this disclosure relate generally to LED (light emitting diode), based systems, such as OLED (organic light emitting diode), front and side emitting LEDS, and thin film transistors driven LEDs, which are embedded in fabric to form a textile article, such as, headwear, clothing articles, gloves, mittens, shoes, carrying packs, tapestries, and other textile articles to provide a desired illumination and display, and to textile articles comprising such LED display systems.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

In one embodiment, a textile display system includes memory operable to store data; a flexible fabric having a plurality of light emitting devices which define a display; and a processor communicatively coupled to the memory and the display. The processor is operable to execute one or more modules in the memory. The modules include a static module displaying a static image; a dynamic module displaying a dynamic image; a situational module displaying a situational image specific to a situational event; a geographical module displaying a geographic image specific to a geographical location; and a motion module displaying a motion image upon detection of movement.

In another embodiment, a textile display system includes memory operable to store data; a flexible fabric having a plurality of light emitting devices which define a display; a camera configured to capture a real-time image; and a processor communicatively coupled to the memory, the camera, and the display. The processor is operable to execute one or more modules in the memory. The modules include a static module displaying a static image; a dynamic module displaying a dynamic image; and a real-time module displaying the real-time image captured from the camera.

In still another embodiment, a method of operating a textile light emitting device system having a flexible fabric with a plurality of light emitting devices which define a display; and a processor communicatively coupled to the memory and the display, has the steps of: initiating the system by an authorized user; selecting a display module; and display an image based on the selected display module. The display modules include a static module displaying a static image; a dynamic module displaying a dynamic image; a situational module displaying a situational image specific to a situational event; a geographical module displaying a geographic image specific to a geographical location; and a motion module displaying a motion image upon detection of movement.

### BRIEF DESCRIPTION OF THE DRAWINGS

FIG. 1 is a block schematic view of a wearable light emitting device display system according to embodiments of the present disclosure.

FIG. 2 is a perspective view of the wearable light emitting device display system of FIG. 1 according to embodiments of the present disclosure.

FIG. 3A is a perspective view of the wearable light emitting device display system of FIG. 1 according to embodiments of the present disclosure, shown in static operational mode with a user.

FIG. 3B is a perspective view of the wearable light emitting device display system of FIG. 1 according to embodiments of the present disclosure, shown in a second embodiment of static operational mode with a user.

FIG. 3C is a perspective view of the wearable light emitting device display system of FIG. 1 according to embodiments of the present disclosure, shown in dynamic operational mode with a user.

FIG. 3D is a perspective view of the wearable light emitting device display system of FIG. 1 according to embodiments of the present disclosure, shown in situational operational mode with a user.

FIG. 3E is a perspective view of the wearable light emitting device display system of FIG. 1 according to embodiments of the present disclosure, shown in geographic operational mode with a user.

FIG. 3F is a perspective view of the wearable light emitting device display system of FIG. 1 according to embodiments of the present disclosure, shown in motion detection operational mode with a user.

FIG. 4 is a block schematic view of a wearable light emitting device display system according to embodiments of the present disclosure.

FIG. 5 is a perspective view of the wearable light emitting device display system of FIG. 4 according to embodiments of the present disclosure.

FIG. 6 is a perspective view of the wearable light emitting device display system of FIG. 4 according to embodiments of the present disclosure, shown in real time imagining operational mode with a user.

FIG. 7 is another perspective view of the wearable light emitting device display system of FIG. 4 according to another embodiment of the disclosure.

FIG. 8 is a flowchart illustrating various steps performed by wearable light emitting device systems according to an embodiment of the present disclosure.

### DETAILED DESCRIPTION

Reference is now made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments.

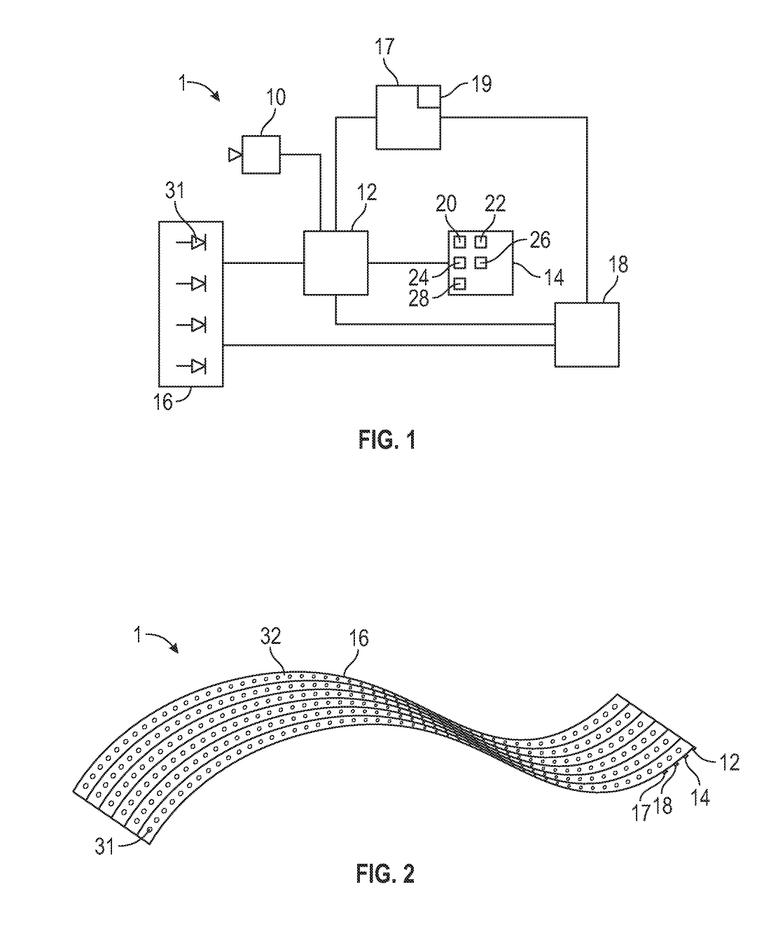

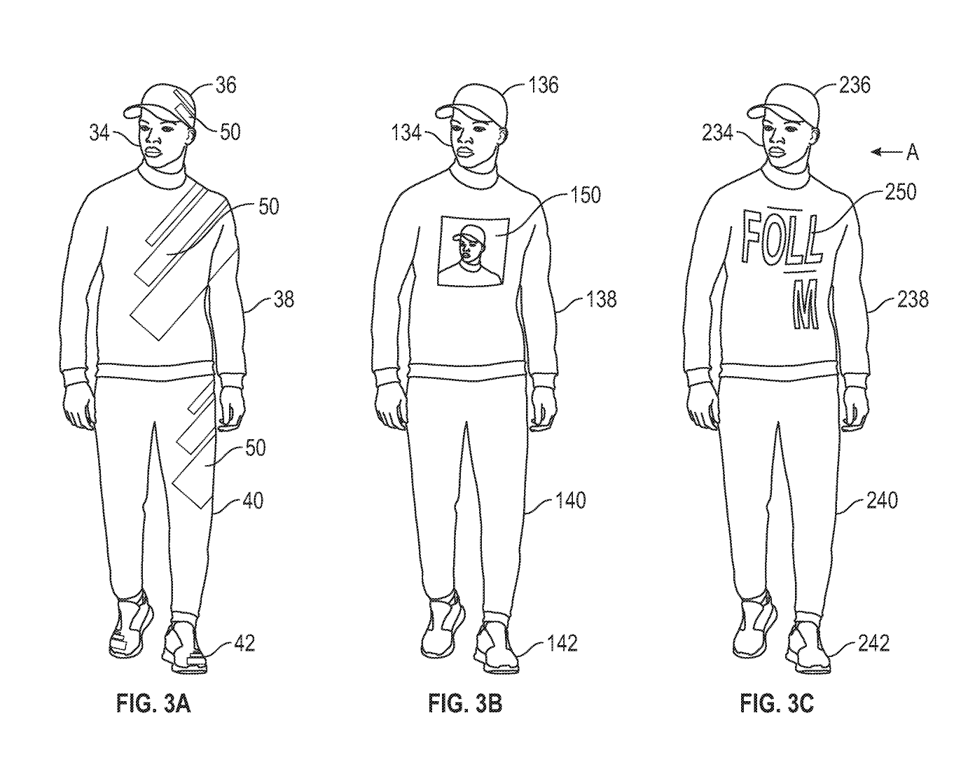

FIGS. 1-2 illustrate an intelligent textile LED display system, which is generally given a reference number 1. For purposes of discussion, the textile LED display system is referred to herein as a wearable LED display system. However, it shall be understood that the textile LED system may be additionally or alternately include other display systems that incorporate a textile, such as a tapestry that may be hung on the wall, seat covers, quilts, etc. The wearable LED display system 1 may include a processor 12, non-transitory computer memory 14, flexible fabric 16 laden with LEDs 31, a transceiver 17, and a power source 18. FIG. 2 illustrates an embodiment of the wearable LED display system 1 as a strip of fabric 16. The LED display system may include a plurality of visual indicators (which may be electrically stimulated) including but not limited to materials that emit light at specific wavelengths such as traditional LEDs or organic LEDs. These types of display technology components operate in the optical transmissive mode. Other supported display technologies can conversely operate in the optical reflective mode, where an external light source must be present in order to become a visual indicator to the observer. One example of reflective mode display technology is programmable matter such as a metamaterial. Using metamaterials, external light can be manipulated to reflect selectively on individual or grouped reflective programmable particles. By changing the shape or the particles' index of refraction, it may be possible to change the apparent color of the material from the observer's perspective.

The processor 12 (or “controller” or “master board”) may be any appropriate device, whether now existing or later developed, which performs the operations specified by the various programming used by the system 1. The processor 12 may be electronic circuitry located on a common chip or circuit board, or may be a distributed processor such that one portion of the processor is physically separate from another portion of the processor. In other words, discrete processing devices may be linked together (e.g., over a network) and collectively form the processor 12. The processor 12 is in data communication with a camera 10, the memory 14, and may further be in data communication with other peripherals (e.g., sensors, keyboards, touch screens, etc.) to control the camera 10 and/or other components.

The controller 12 performs the tasks of processing retrieving modules and/or data from the memory 14 and controlling the different components of the system 1, including the transceiver 17. The controller 12 may receive instructions from an outside source (i.e. mobile application, personal computer, laptop or other means known in the art or yet to be known) by means of the transceiver 17. Such instructions may be the selection of the mode to display as will be further discussed below. Such instructions may be the download of patterns or logos to be displayed, for example from an outside database of images and patterns. Such instructions may be received directly from memory 14 and not through an outside source.

The transceiver 17 may include a transmitter (or “antenna”) 19. The antenna 19 may be situated in a different location than the transceiver 17. For example, the antenna 19 may be a part of circuitry located in the fabric 16 or the transceiver 17 may be one of many transceivers located within the wearable LED display. The transceiver 17 communicates directly and/or over a wireless communication infrastructure with other devices configured to receive such wireless communication to provide controlled input to the LEDs 31. In direct wireless communications, the transceiver 17 may include baseband processing circuitry to convert data into a wireless signal (e.g., radio frequency (RF), infrared (IR), ultrasound, near field communication (NFC), et cetera) and the transmitter 19 transmits the wireless signal. When a second wireless transceiver (not shown) is within range (i.e., is close enough to the first wireless transceiver 17 to receive the wireless signal at a sufficient power level), it receives the wireless signal and converts the signal into meaningful information (e.g., voice, data, video, audio, text, instructions for completing a task, et cetera) via baseband processing circuitry (e.g., through an application on a phone, GPS, computer, notepad, etc. or through a central display located within the home). Examples of direct wireless communication (or point-to-point communication) include Bluetooth, ZigBee, Radio Frequency Identification (RFID), et cetera.

For indirect wireless communication or communication via a wireless communication infrastructure, the first wireless transceiver 17 transmits and/or receives a wireless signal to a base station or access point, which conveys the signal to a wide area network (WAN) and/or to a local area network (LAN). The signal may traverse the WAN and/or LAN to a second base station or access point to send signal to the second wireless transceiver or it may traverse the WAN and/or LAN directly to the second wireless transceiver. Examples of wireless communication via an infrastructure include cellular satellite/tower, IEEE 802.11, public safety systems, et cetera.

The memory 14 contains the relevant computer or program instructions for the controller 12, and may further include location data that may be gathered from a global positioning satellite (GPS) system. The data may be transmitted by the transmitter 19 as described above to obtain the location of the wearable LED system 1. The memory 14 may be situated in the same circuit board as the controller 12 and power source 18.

The memory 14 may include volatile and non-volatile memory, and any appropriate data storage devices whether now existing or later developed may be used. Further, the memory 14 may be a unitary memory in one location, or may alternately be a distributed computer memory such that one portion of the computer memory 14 is physically separate from another portion of the memory 14. Example memory devices which may be employed include SRAM, DRAM, EPROM, EEPROM, Flash, magnetic, rotating media, ferromagnetic, and U3 smart drives. The memory 14 is in communication with the controller 12 for providing data to and receiving data from the controller 12. In some embodiments, data may be encrypted to prevent disassembly and reverse engineering.

The memory 14 may include, for example, a program storage area (for storing software or “instructions”) and a data storage area (for storing videos, still photographs, and other data). In some embodiments, the software components stored in memory 14 may include a static operation module 20, a dynamic operation module 22, situation based module 24, geographical operation module 26, motion module 28, real time image module 30. It is foreseen that the memory 14 may further include an operating system.

The static operation module 20 is configured to display a single image (e.g., a color, a pattern, a logo, etc.) which remains stationary while the static operation module 20 is in use. Conversely, the dynamic operation module 22 is configured to display an image which moves while the dynamic operation module 22 is in use. For example, the image may flash, scroll, rotate, or otherwise move on the respective display. The situation based module 24 may be configured for static or dynamic operation, the image being selected based on the user's specific situation (e.g., if the user is lost). Similarly, the geographical operation module 26 may be configured for static or dynamic operation, the image being selected based on the user's geographical location. Each of the static module 20, the dynamic module 22, the situation based module 24, and the geographical operation module 26 may be activated by the user, e.g., through an on/off button. The on/off button may be located somewhere on one or more of the displays, or may be remote (e.g., on the user's phone or the phone of a party authorized by the user such as a parent on behalf of a child). The motion module 28 may similarly be configured for static or dynamic operation. However, the motion module 28 may be activated by movement of the user (e.g., instead of turning the module 28 on or off via a button). In embodiments, the motion module 28 may be turned on (e.g., via an on/off button as described above), but the image may not be triggered to turn on until the module 28 experiences movement by the user. The real-time image module 30 is configured to interact with a camera 10 to display images that are received from the camera 10. The various modules 20, 22, 24, 26, 28, and 30 are described in greater detail with reference to the examples below.

The controller 12 is configured to retrieve from memory 14 and execute, among other things, instructions or modules related to the control processes and methods described herein. The controller 12 is connected to the memory 14 and may execute software instructions or modules that are stored in a RAM of the memory 14 (e.g., during execution), a ROM of the memory 14 (e.g., on a generally permanent bases), or another non-transitory computer readable medium such as another memory or a hard disc. For example, software can be stored in the internal memory of the controller board 14. The controller 12 can have part of its operations dedicated to a data transfer function between the camera 10 to the memory 14, and another part dedicated to the fabric LED array 16. Alternately, the controller 12 can embody the two functions in separate controllers (i.e., a data transfer function controller and a LED controller).

The flexible LED fabric 16 may be stretchable, conformable, thin-film transistor (TFT) driven LED display that is laminated or otherwise incorporated into fabric textiles which features a plurality of LED lights. The electronics (i.e. processor 12, memory 14, etc.) may be integrated with the textile, on the surface of textiles, or may be an iron-on patch. The LED displays 31 may manufactured from flexible material. Examples of flexible materials used for the LED strip include polymer/plastic substrates, such as, polyamide, polyether ether ketone (PEEK) or transparent conductive polyester film. For example, a polyimide substrate may be encapsulated in rubber, which would allow the display 31 to be laminated into fabric 16. The at least one flexible LED display strip 16 may be able to conform to the shape of the surface of a wearable article or of a user (i.e. spandex), said flexible strip comprising an upper surface 32 having one or more LEDs 31 disposed thereon which are operably positioned to provide a desired illumination; an electrical connector for electrically connecting the LED strip 16 to a power source 18; and may further include an electrical connector for electrically connecting the LED fabric strip 16 to a computer or other device so as to install additional programming or additional licensing for trademarks to be displayed. It is foreseen that this invention applies to any controllable light emitting device known or yet to be known and should not be limited to LEDs or OLEDs.

The power source 18 may be located within the flexible LED fabric 16 or may be located remotely. The power source 18 of a system 1 can be one or more of: batteries, a computer battery through a USB connection, a motion-based generator, a solar cell, or other source of electricity such as a fuel cell or other means known in the art. It may be beneficial for the system 1 to include means for storing power, both in situations in which the system 1 is hard wired to an electrical box, and where the system receives its power from an outside source. Here, the power source 18 may be capacitors or a battery, such as NiCd (nickel-cadmium), NiZn (nickel-zinc), NIMH (nickel-metal hydride), or lithium-ion. The battery may store energy from other sources which may then be converted into electrical energy for use by the system 1. For example, the system may be able to capture solar energy through a photo-voltaic cell. As another example, the power source 18 may be a capacitor or have a capacitor back-up that receives power until fully charged, then, the capacitor provides temporary power to the system 1, such that even when the battery 18 becomes discharged, the system 1 will stay on for a short time. The system 1 may, for example, provide an indication (e.g., a sound, a displayed message, a flashing LED, etc.) to the user that the battery 18 is low or that the capacitor is being used and replace the power source 18 soon.

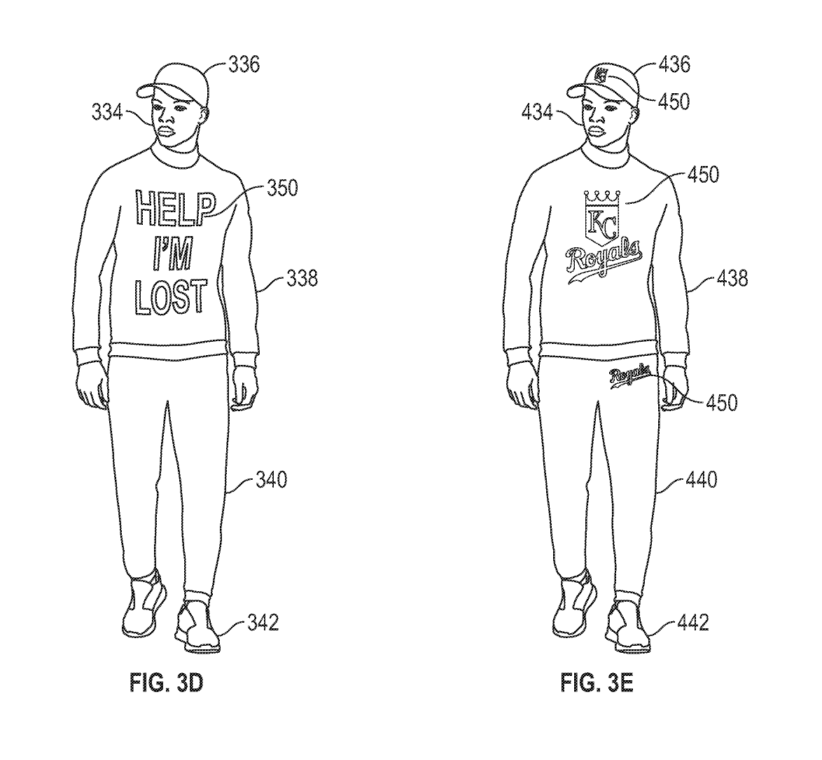

With reference now to FIG. 3A, a user 34 is wearing a controllable LED display hat 36, a controllable LED display sweater 38, controllable LED display pants 40, and a controllable LED display shoes 42. Each of the wearable LED displays 36, 38, 40, 42 is made up of one or more fabric LED systems 1 as disclosed above. The LED displays 36, 38, 40, and 42 may each be in static operation under control of controller 12 utilizing the static operation module 20. Alternately, one or more wearable LED displays 36, 38, 40, 42 may be controlled by the static operation module 20 while the respective other wearable LED displays 36, 38, 40, 42 may be controlled by a different module 22, 24, 26, 28, or 30, as will be further discussed below.

As noted above, the static operation module may control the individual LEDs 31 in the wearable LED displays 36, 38, 40, 42 to display a single color or a single pattern 50, for example: paisley, plaid, stripes, denim, floral, or other patterns known in the art or yet to be known. The memory 14 may have the patterns 50 stored for the static module 20 to recall and display. The color depth may be 24 bit or 32 bit or other color depth yet to be known. The wearable LED displays 36, 38, 40, 42 may be set to be the same static pattern or may each individually be their own static pattern.

Another example of static operation is illustrated in FIG. 3B. There, a user 134 is wearing a controllable LED display hat 136, a controllable LED display sweater 138, controllable LED display pants 140, and controllable LED display shoes 142, each of which is under control of controller 12 utilizing an operation module such as the static operation module 20. The controllable wearable LED displays 136, 138, 140, and 142 are substantially similar to counterpart wearable LED displays 36, 38, 40, and 42, except as specifically noted and/or shown, or as would be inherent. In this embodiment, the static pattern 150 is an image on the controllable LED display sweater 138. The image 150 may be repeated throughout the sweater 138 or on other controllable LED displays 136, 140, 142. The image 150 may be stored on memory 14 and displayed randomly or centrally or determined by the user 134. The image 150 may be any type of file format, such as JPEG, Exif, TIFF, GIF, BMP, PNG or any other format known or yet to be known.

With reference now to FIG. 3C, a user 234 is wearing a controllable LED display hat 236, a controllable LED display sweater 238, controllable LED display pants 240, and controllable LED display shoes 242, each of which is under control of controller 12 utilizing an operation module such as the dynamic operation module 22. The controllable wearable LED displays 236, 238, 240, and 242 are substantially similar to counterpart wearable LED displays 36, 38, 40, and 42, except as specifically noted and/or shown, or as would be inherent. In the illustrated example of FIG. 3C, the dynamic phrase 250 “Follow Me” scrolls in direction A across the user's sweater 238, and may repeat as the phrase ends on the left side of the controllable wearable LED display sweater 238. It shall be understood that the image 250 may be dynamically displayed on any of the wearable LED displays 236, 238, 240, 242. Like the static operation module 20, the dynamic operation module 22 controls the individual LEDs 31 in the wearable LED displays 236, 238, 240, 242 to display the dynamic phrase 250.

The memory 14 may store one or more dynamic patterns 250 for the dynamic module 22 to recall and display. The dynamic patterns 250 may include detailed motion patterns for each wearable display 236, 238, 240, 242 that may be used or worn. The moving image 250 may be displayed at locations randomly selected or centrally-located or at (a) location(s) determined by the user 234. The image 250 may be of any type of video file format, such as MPEG, MOV, WMV, AMV, MP4, MPG, M4V or any other format known or yet to be known. The wearable LED displays 236, 238, 240, 242 may be configured to play a movie or a moving image from memory 14 or a video sent to a cellular device which may be accessed via the controller 12.

In FIG. 3D, a user 334 is wearing a controllable LED display hat 336, a controllable LED display sweater 338, controllable LED display pants 340, and controllable LED display shoes 342, each of which is under control of controller 12 utilizing a module such as the situational module 24. The controllable wearable LED displays 336, 338, 340, and 342 are substantially similar to counterpart wearable LED displays 36, 38, 40, and 42, except as specifically noted and/or shown, or as would be inherent. A user 334, such as a child, may be wearing the wearable LED displays 336, 338, 340, 342. An outside source, such as the child's parent's phone may communicate with the transceiver(s) 17 of the wearable LED displays 336, 338, 340, 342 to change the display format of the wearable LED displays 336, 338, 340, 342 to a specific distress or aid pattern 350. Like the static operation module 20 and the dynamic operation module 22, the situational module 24 controls the individual LEDs 31 in the wearable LED displays 336, 338, 340, 342 to display a situation specific pattern 350. In FIG. 3D, the situational phrase 350 “HELP I'M LOST” may optionally be held static or may be in motion on the wearable LED display sweater 338. The situational phrase 350 may be displayed across one or more controllable wearable LED displays 336, 338, 340, and 342. Other exemplary situational phrase may include phrases such as “Call 911, I have been kidnapped,” or “If found please contact parents at (913) 555-5555.” The wearable LED displays 336, 338, 340, 342 may adjust the viewing angle such that only other small children or short individuals at the user's 334 height may see the situational pattern 350 and those above the height cannot or vice versa. The memory 14 may have static or dynamic situational patterns 350 stored for the situational module 24 to recall and display.

There may also be a panic button on one or more wearable LED displays 336, 338, 340, 342, in lieu of, or in combination with the transceiver 17, which may allow the user 334 to change to the situational pattern 350 at will.

In still another example, illustrated in FIG. 3E, a user 434 is wearing a controllable LED display hat 436, a controllable LED display sweater 438, controllable LED display pants 440, and controllable LED display shoes 442, each of which is under control of controller 12 utilizing an operation module such as the geographical operation module 26. The controllable wearable LED displays 436, 438, 440, and 442 are substantially similar to counterpart wearable LED displays 36, 38, 40, and 42, except as specifically noted and/or shown, or as would be inherent. In FIG. 3E, the geographical pattern or logo 450 is displayed on one or more of the controllable LED displays 426, 438, 440, 442 and may be held static or may be in motion, for example by blinking, repeating, or striping across the LED display(s). Like the static operation module 20 and the dynamic operation module 22, the geographical module 26 controls the individual LEDs 31 in the wearable LED displays 436, 438, 440, 442 to display a geographical specific pattern 450.

The geographical pattern 450 may be based on geographical points of interest near the location of the user 434. In embodiments, transceiver(s) 17 of the wearable LED displays 436, 438, 440, 442 communicate with a GPS to obtain location data which may be communicated to the controller 12. In the illustrated example, the controller 12 may determine that the user 434 is located either around the Royals® stadium or Kansas City area, and one or more of the wearable LED displays 436, 438, 440, 442 may automatically activate to display a Royals® logo 450. Alternately, the user 434 may cause one or more of the LED displays 436, 438, 440, 442 to exhibit the geographic pattern 450, e.g., by engaging with the module 26 to activate or deactivate the image 450. The location of the display 450 (e.g., which one or more of the LED displays 436, 438, 440, 442 will show the logo and/or where on the display 436, 438, 440 and/or 442 the logo may be located) may be predetermined by the user 434. The geographical module 26 is envisioned to be on or off as specified by the user 434.

In embodiments, the memory 14 may have multiple designs and/or patterns stored thereon which may be associated with a particular geographic location. The user 434 may be able to select the desired design or pattern 450 for exhibition by interacting with the module 26 (e.g., via a button or corresponding module on a smart phone or other electronics device). For example, the user 434 may prefer to simply display a “KC” design while in Kansas City or around Kauffman stadium without specifically showing support for the Royals. Accordingly, the user 434 may scroll through the various stored designs or patterns 450 until s/he reaches the one which is most appealing; that design 450 may thus be displayed. As described herein, the designs and/or patterns 450 may be static or dynamic.

In one embodiment, a system 1 may include a plurality of processors 12 in communication, wherein each processor 12 contains a unique identifier known as a Media Access Control Address (or MAC Address). Each MAC Address may be encoded into the memory 14 as a non-volative unique identification code that can be machine readable (and optionally writable) and/or human readable through means of network data communication or display patterns on the fabric of the system 1. The system 1 may be used to momentarily display visual codes or geometrically colored patterns on each localized subsystem in such a way that a supervisory observing system monitor could uniquely identify each individual subsystem. An observing system management controller may identify, authenticate, and intercommunicate with several subsystem processor 12 modules in order to compile and seamlessly display cascaded orchestrated patterns on the system 1 via the plurality of processors 12.

In an embodiment, the application of the system 1 may provide a programmable real-time motion capture tool which may be an advanced tracking marker to be worn by actors and/or mounted on objects being filmed during production of computer-generated-imagery (CGI) for special effects by filmmakers. Three dimensional positioning can be resolved and refined in real-time by utilizing changing patterns on the wearable LED display(s) during filming as well as assist in chroma-key production technique enhancements such as color key avoidance and specific queue markers being displayed at critical time-markers during the scene.

Moving on, in FIG. 3F, a user 534 is wearing a controllable LED display hat 536, a controllable LED display sweater 538, controllable LED display pants 540, and controllable LED display shoes 542, each of which is under control of controller 12 utilizing an operation module such as the motion detection module 28. The controllable wearable LED displays 536, 538, 540, and 542 are substantially similar to counterpart wearable LED displays 36, 38, 40, and 42, except as specifically noted and/or shown, or as would be inherent. In the illustrated example of FIG. 3F, the motion pattern or logo 550 may be held static or may be in motion. Like the static operation module 20 and the dynamic operation module 22, the motion module 28 controls the individual LEDs 31 in the wearable LED displays 536, 538, 540, 542 to display a specific pattern 550 when it is determined by the controller 12 that the user 532 is running, jumping, or otherwise moving. In other words, the controllable wearable LED displays 536, 538, 540, and 542 may exhibit to the predetermined motion pattern 550 upon movement by the user 534. The transceiver(s) 17 of the wearable LED displays 536, 538, 540, 542 may communicate with a GPS to obtain location data, this location data is communicated to the controller 12 to ascertain movement. Motion may be detected through other means, such as an accelerometer, gyroscope, motion detector, camera, gesture detection, or other means known or yet to be known.

In the illustrated example, the controller 12 determines that the user 534 is moving from a stationary position 560 to a running position 561, and the wearable LED displays 536, 538, 540, 542 may each individually or all change to a Flash® logo pattern 550 on the wearable LED sweater 536 with lightning being displayed across the wearables LED displays 538, 540, 542. The motion module 28 is envisioned to be on or off as specified by the user 534. The memory 14 may have static or dynamic patterns or logos 550 stored for the motion module 28 to recall and display.

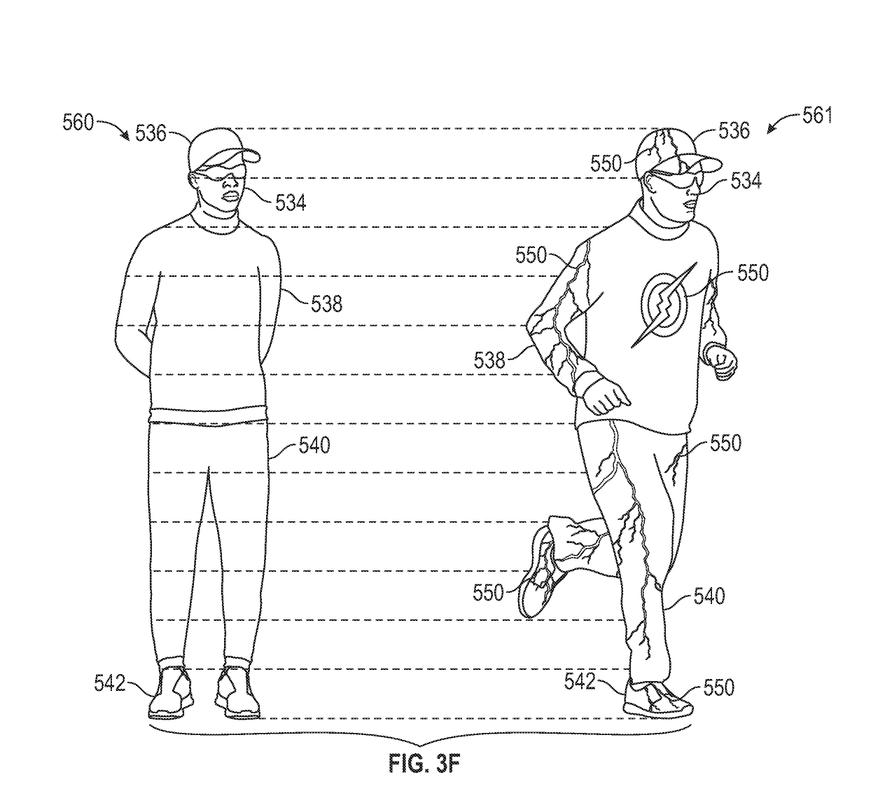

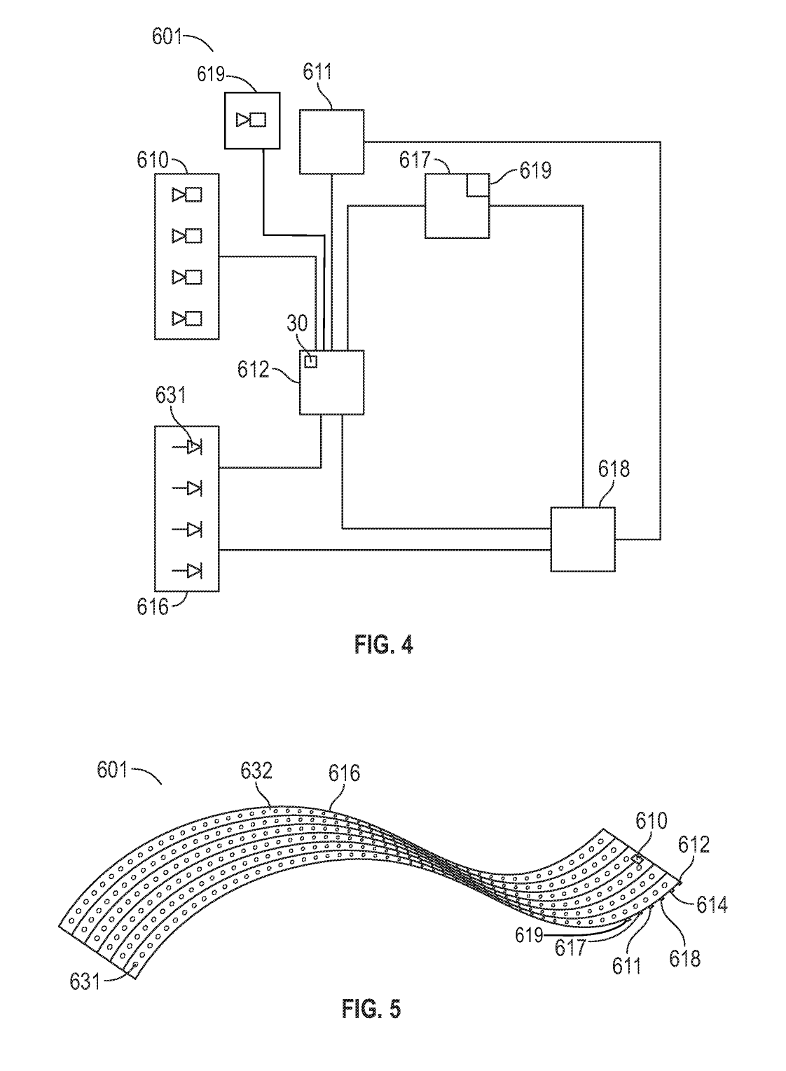

FIGS. 4-5 illustrate an intelligent wearable LED display system, which is generally given reference number 601. The wearable LED display system 601 may include a camera 610, a gyroscope 611, a processor 612, memory 614, a flexible fabric 616 laden with LEDs 631, a transceiver 617, and a power source 618. FIG. 5 illustrates an embodiment of the wearable LED display system 601 as a strip of fabric 616. While elements are often referred to in the singular, those skilled in the art will appreciate that multiple such elements may often be employed and that the use of multiple such elements which collectively perform as expressly or inherently disclosed is fully contemplated herein. For example, in embodiments, the gyroscope 611 may be an array of gyroscopes situated so as to monitor the movement of the user 734.

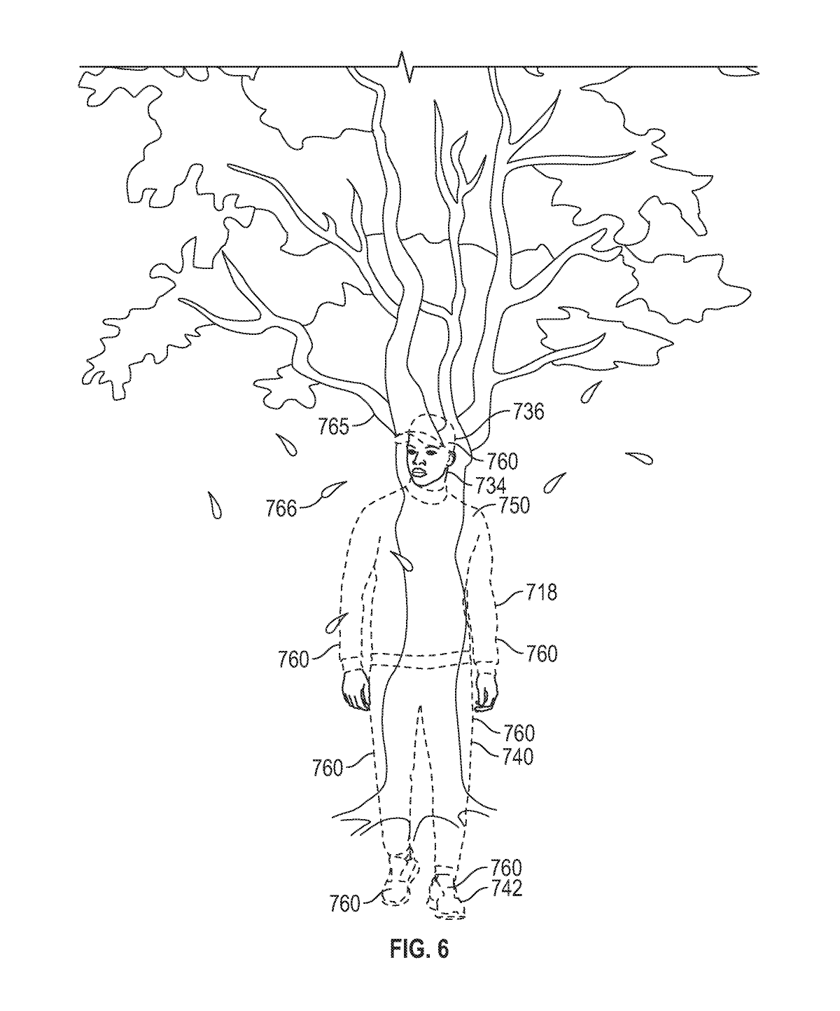

The processor 612, memory 614, the flexible fabric 616 laden with LEDs 631, the transceiver 617, and the power source 618 are substantially similar to counterpart components illustrated in FIG. 1, except as specifically noted and/or shown, or as would be inherent. The system 601 may have the same functionality as the system 1 described above, with further functionality as described with reference to FIG. 6.

In FIG. 6, a user 734 is wearing a controllable LED display hat 736, a controllable LED display sweater 738, controllable LED display pants 740, and controllable LED display shoes 742, each of which is under control of controller 12 utilizing a module such as the real time image module 30. The controllable wearable LED displays 736, 738, 740, and 742 are substantially similar to counterpart wearable LED displays 36, 38, 40, and 42, except as specifically noted and/or shown, or as would be inherent. Each of the wearable LED displays 736, 738, 740, 742 may be made up of one or more fabric LED systems 601 as described above. An image 750 may be exhibited on one or more controllable wearable LED displays 736, 738, 740, and 742, similar to the other embodiments described above. The image 750 may be static or, as shall be appreciated by the description provided below, preferable the image 750 may be dynamic. The real time image module 30 controls the individual LEDs 731 in the wearable LED displays 736, 738, 740, 742 to display the real time image 750 captured by the camera 610.

The camera 610 (or “imaging module” or “optical sensor” or cameras) may be configured to continuously record or to record upon a trigger such as motion, and may store recorded sessions in the memory 614. The camera 610 may capture still images or video, may include filters to adjust for lighting, and may be a visible light camera, low light camera, or an infrared camera, or combinations thereof. In embodiments, the camera 610 may have a wide-angle lens so as to capture the widest area possible. The camera 610 may be connected with a network and accessible (e.g., via a laptop or other computer). The camera 610 may be located in a single place, such as the back of collar of a shirt, the wrist of a mitten, the brim of a cap, or other location known. While this document shall often refer to elements in the singular, those skilled in the art will appreciate that multiple such elements may often be employed and that the use of multiple such elements which collectively perform as expressly or inherently disclosed is fully contemplated herein. In some embodiments, the camera 610 may be an array of cameras situated so as to get a complete wide angle view of an area.

A user 734 may be wearing the controllable wearable LED displays 736, 738, 740, and 742, and the camera 610 may capture the image behind the user 734. The controller 12 may cause the captured imaged to be exhibited by one or more of the LED displays 736, 738, 740, 742, such that the user 734 appears at least partially see-through or camouflaged with the background. As shown in FIG. 6, the wearable LED displays 736, 738, 740, 742 may each individually display a respective portion of the tree 765 behind the user 734 such that the user 734 is substantially invisible to a viewer.

In one embodiment, the image 750 may be manipulated based on the perspective of a viewer. Each viewer of the user 734 has a specific vantage point that is dependent on the distance from the user 734, and the height of the viewer. For example, a person short of stature that is viewing the user 734 from a short distance will have a different perspective than a person who is very tall. However, as the distance between the viewer and user 734 increases, the viewer's perspective becomes less significant. In order that the viewer always has the most accurate view of the user 734 (or lack thereof, since the user 734 may be substantially see-through) the camera 610 may be configured to swivel to take into account the viewer's perspective. In order for the system 601 to determine the viewer's perspective, the distance from the viewer to the user 734 must first be determined. A distance finder, such as a laser (or an array of lasers) or a second camera may be utilized in conjunction with the controller 612 to determine the distance from the user to the viewer according to known techniques. As noted above, each viewer's perspective may be substantially similar at longer distances. Accordingly, the controller 612 may cause the distance finder to additionally ascertain the height of the viewer according to known techniques if the distance between the viewer and the user 734 is less than a predetermined threshold (e.g., 5 feet, 10 feet, 15 feet, etc.).

Where the distance finder determines the distance and the height of the viewer, the controller 612 may be able to determine the viewing angle between the viewer and the user 734. The controller 612 may adjust the camera angle accordingly. For example, if the viewer is short of stature and is standing close to the user 724, the camera 610 may be adjusted such that it has a more upwardly-angled trajectory. The viewer may see, for example, the top of the tree and a portion of the sky. Alternately, where the viewer is tall, the camera 610 may be adjusted such that it has a more downwardly-angled trajectory. The viewer may see, for example, the trunk of the tree and a portion of the ground. If the distance between the viewer and the user 734 is greater than the predetermined threshold, then the camera 610 may be positioned such that it is pointed straight behind the user 734. In this way, the perspective of the viewer may be taken into account to ensure that the view is as accurate as possible.

The user 734 may either be stationary or moving. Where the user 734 is moving, the gyroscope 611 determines the angle and location of an appendage 760 (e.g., leg, arm, head, etc.) of the user 734, so as to determine the viewer's viewing angle of the appendage. When an arm 760 of the user 734 moves or rotates, the real time image 750 adjusts to show the background at that location, so that the user 734 still remains see-through.

It is preferable that the image 750 is displayed in real time. Accordingly, as illustrated in FIG. 6 and according to our example, a leaf 766 may fall off the tree 765. The camera 610 may capture the real time image 750 of the leaf 766, and the image 7570 will show the leaf to the viewer in sync with the leaf as it falls or blows past the user 734.

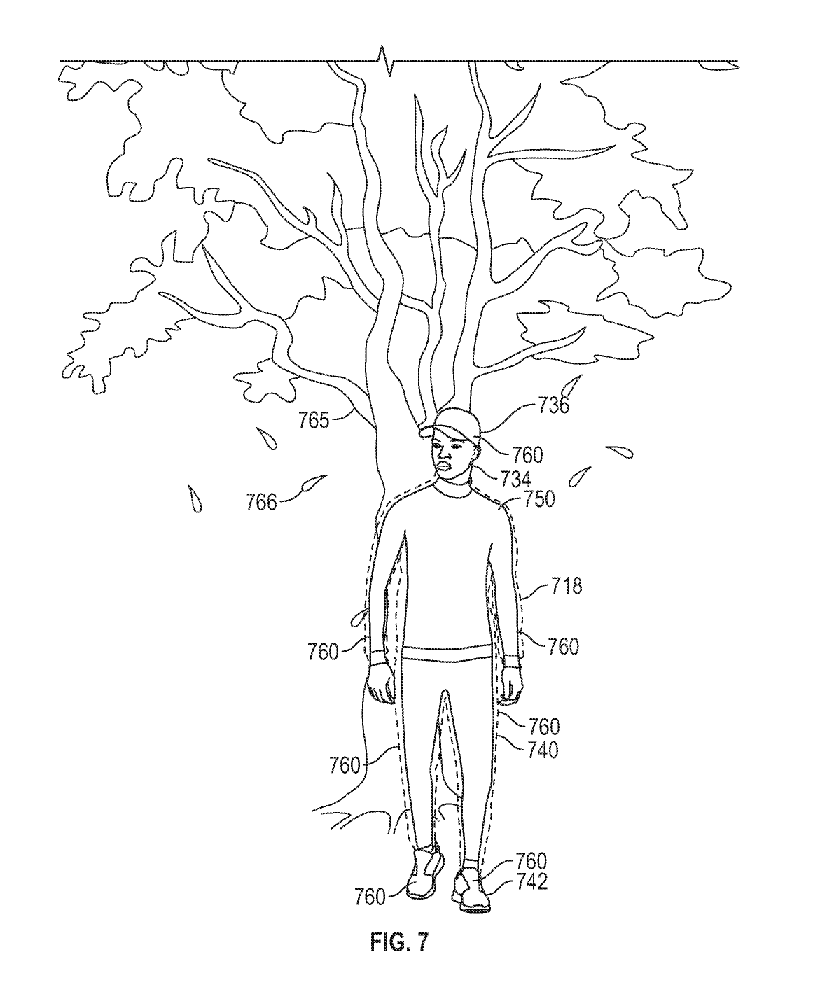

In still another embodiment illustrated in FIG. 7, which is substantially similar to the embodiment illustrated in FIG. 6, LEDs of the LED displays 746, 738, 740, and 742 may be selectively activated such that portions of the user 734 may appear see-through, while other areas appear as the user's 734 normal clothes (which may or may not display other images such as those described herein). The user 734 may desire to alter his or her physique. Accordingly, as part of the real-time image module 30, the user 734 may interact with the controller 612 (e.g., through an interface on a mobile device) to selectively activate certain LEDs on one or more LED displays. For example, the user interface may allow the user 734 to select from one or more predetermined “desired physiques.” The desired physiques may include selections such as “Mesomorphic” (e.g., athletic), “Endomorphic” (e.g., strong), or “Ectomorphic” (e.g., lean and thin). The selections may include sub-selections, which may allow the user 734 to further define the type of build s/he wishes to portray. For example, a user 734 may select “Mesomorphic” and further select “Body-Builder” which, when activated, will give the user 734 apparently well-defined muscles from the perspective of the viewer.

In addition to the user 734 inputting his or her desired physique, additional details may be required, including the user's sex, height, and weight. The controller 612 may use this information to determine exactly which LEDs are selectively activated to provide the user 734 with the desired physique. For example, a user 734 who is heavyset will require fabric 616 having a greater number of LEDs to begin with. Therefore, fewer of the overall LEDs will be required to be activated in order to achieve an ectomorphic physique. Conversely, a user 734 who is thinner will require fabric 616 having fewer LEDs to begin with. Accordingly, more of the overall LEDs will be required to be activated in order to achieve an ectomorphic physique. Those of skill in the art shall therefore understand that the system 601 may be capable of selectively altering the shape of an individual based on the individual's preferences.

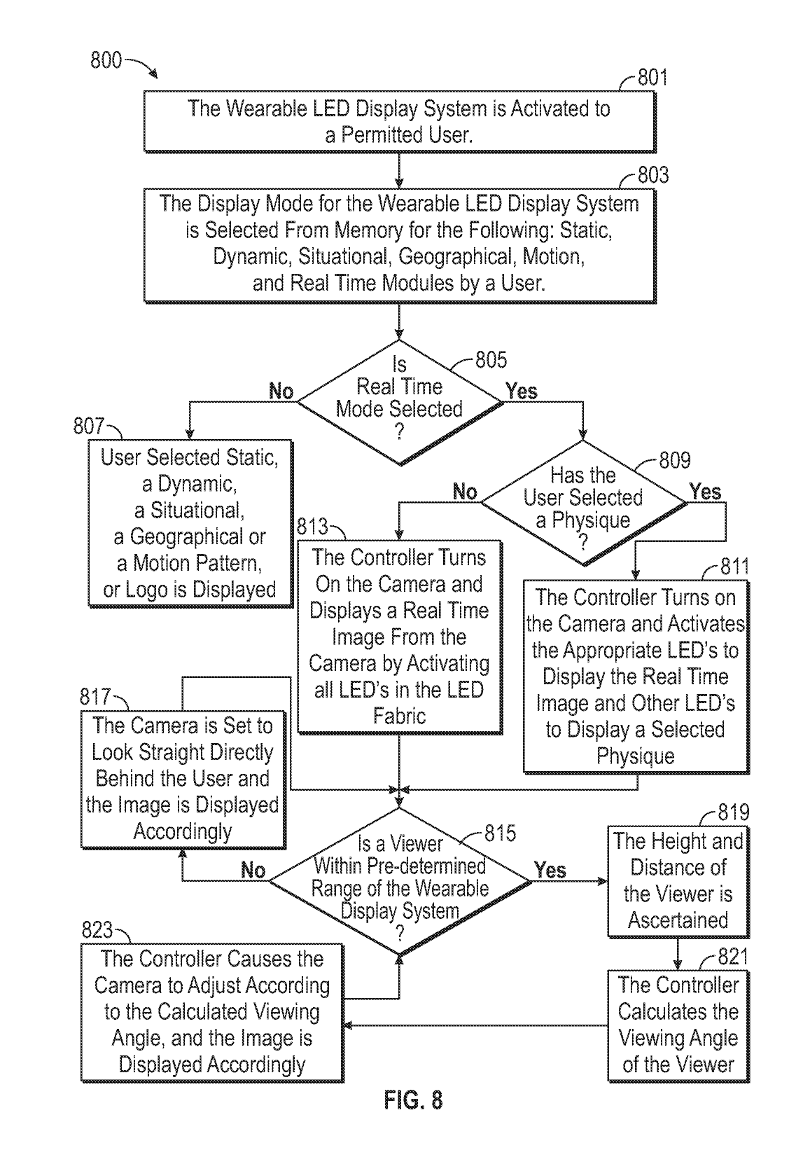

FIG. 8 illustrates some steps 800 that may be employed by the various systems described herein to display a static or dynamic image. In step 801, the wearable LED display system 1 is activated to a permitted user 34. Such activation may be through a dongle, biometrics, mobile application, login, user interface, button press, or other means. In step 803, the display mode for the wearable LED display system 1 is selected by a user from the following modules stored in memory 14: static, dynamic, situational, geographical, motion, and real time.

In step 805, it is determined whether real time display mode is selected. In step 807, if real time mode is not selected, then the user selected static 50/150, dynamic 250, situational 350, geographical 450, or motion 550 pattern or logo is displayed. It is foreseen that other images or patterns may be downloaded to the memory 14 to display on the wearable LED display system 1. It is also foreseen that the image or pattern may be from a different memory source.

In step 809, if real time mode is selected, it is determined whether the user has selected a physique, e.g., “Mesomorphic,” “Endomorphic,” or “Ectomorphic.” If the user has selected a physique, the controller at step 811 turns on the camera 10 and activates the appropriate LEDs to display the user with the selected physique and the LEDs not displaying the selected physique are activated to display the real-time image. If the user has not selected a physique, at step 813, the controller 12 turns on the camera 10 and displays a real time image from the camera 10 by controlling all LEDs in the LED fabric 16 (as opposed to some) to display the real time image.

Moving on, regardless of the decision at step 809, at step 815, it is determined (e.g., via the distance finder) if there is a viewer within a pre-determined range of the wearable display system 1. In step 817, if a viewer is not within the predetermine range, then the camera is set to look straight directly behind the user and the image behind the user is displayed accordingly. The process repeats back to step 815 at timed intervals to determine if a viewer ever becomes within range.

In one embodiment, the LEDs may serve as spatial markers. Alternatively, spatial markers may be provided separately from the LEDs. The markers may be configured for recognition by a detection device which may be a part of a 3D mapping system. The markers may allow the wearable display system to communicate with the detection device and related systems and/or other wearable displays. In one example, a wearable display system equipped with markers is configured for use in a theater environment. The detection device may track the location of the markers on the wearable display system worn by an actor (as well as markers which may be located in or around the environment of the wearable display system, such as the stage) and communicate the information to a spotlight. The spotlight may thus be able to track the location of the actor.

In another example, a detection device may be configured to track the location of multiple wearable displays via the markers and provide a controlled response based on location information of the wearable displays. Here, the detection device may receive location information from the wearable displays. If the detection device determines that the wearable displays are in a location associated with an event, it may send a signal to the wearable displays causing the wearable displays to display a congruous image. If, for example, a plurality of wearable displays is in a stadium, the detection device may determine that the location of the wearable displays in relation to the rest of the stadium places the wearable displays in the visiting team section. The detection device may send a signal which activates the plurality of wearable displays to, for example, display the visiting team's logo across the plurality of wearable displays.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. Further, it will be understood that certain features and subcombinations may be of utility and may be employed within the scope of the disclosure.

Various steps set forth herein may be carried out in orders that differ from those set forth herein without departing from the scope of the present methods. This description shall not be restricted to the above embodiments. It is to be understood that while certain forms of the present invention have been illustrated and described herein, it is not to be limited to the specific forms or arrangement of parts described and shown.

1.-11. (canceled)

12. A textile display system comprising:
a memory operable to store data;
a flexible fabric comprising a plurality of light emitting devices defining a display, the flexible fabric being configured as an item of clothing to be worn by a user;
a camera configured to capture an image in real-time in a first direction;
a distance finder secured to the flexible fabric, the distance finder configured to continuously measure a distance in a second direction from the user to a viewer and communicate with the processor the measured distance, wherein the second direction is not the same as the first direction; and
a processor communicatively coupled to the memory, the camera, the distance finder, and the display; the processor operable to execute a real-time display module in the memory, the real-time module operating to display the real-time image captured by the camera, wherein the real-time image is adjusted in real-time based on the measured distance from the distance finder;
wherein the distance in the second direction comprises at least a viewing angle of the viewer, and the adjustment of the real-time image is based on the viewing angle.

13. The textile display system of claim 12, further comprising a gyroscope in communication with the processor, the gyroscope configured to monitor the position of at least one body part covered by the flexible fabric.

14. The textile display system of claim 12, wherein the camera is positioned on the user facing in a first direction, and the real time image from the camera is shown on a portion of the display, the portion being opposite the first direction.

15. The textile display system of claim 14, wherein the distance finder is configured to additionally determine a viewing angle of the viewer in real-time, the viewing angle being communicated to the processor and the real-time image being continuously adjusted based on the determined viewing angle.

16. A textile display system comprising:
a memory operable to store data;
a flexible fabric comprising a plurality of light emitting devices defining a display and one or more items of clothing worn by the user, the items of clothing defining a physique outline;
a camera configured to capture a real-time image; and
a processor communicatively coupled to the memory, the camera, and the display; the processor operable to execute:
a static module displaying a static image;
a dynamic module displaying a dynamic image;
a real-time module displaying the real-time image captured from the camera; and
a physique-selection module displaying an updated physique outline, the updated physique outline being created by selectively activating one or more of the light emitting devices on the one or more items of clothing based on a user selected physique, the user selected physique including at least one of: mesomorphic physique, endomorphic physique, and ectomorphic physique.

17. The textile display system of claim 16, wherein the camera is positioned facing in a first direction, and the real-time image from the camera is shown on a portion of the display, the portion being opposite the first direction.

18. The textile display system of claim 17, wherein the portion of the display showing the real-time image defines the physique outline.

19. The textile display system of claim 16, wherein the one or more items of clothing includes at least one of the following: a hat, a sweater, a shirt, a pair of pants, and shoes.

20. (canceled)
